(19) United States
(12) Patent Application Publication
(10) Pub. No.: US 2012/0229880 A1
(43) Pub. Date: Sep. 13, 2012

(54) OPTICAL COMPONENT SYSTEM

(76) Inventors: Jozef Sofka, Binghamton, NY (US); Robert Joseph Kolbet, Macedon, NY (US); Gregory Alan Terrance, Rush, NY (US); James Stephen Moronski, Vestal, NY (US); Colin James Coon, Trumansburg, NY (US)

(21) Appl. No.: 13/351,858

(22) Filed: Jan. 17, 2012

Related U.S. Application Data
(60) Provisional application No. 61/433,098, filed on Jan. 14, 2011.

(51) Int. Cl. G02B 26/08

(52) U.S. Cl. 359/221.2; 359/226.2; 359/226.1

(57) ABSTRACT

The subject of the invention is a mechanical device for inserting one out of a multitude of optical components (such as filters) in an optical path and changing the angle of incidence between the incoming light and the selected optical component independently of the optical component selection.

### CROSS-REFERENCE TO RELATED APPLICATIONS

The present application claims the benefit of U.S. Provisional Patent Application 61/433,098 filed Jan. 14, 2011, the entire disclosure of which is hereby expressly incorporated by reference.

STATEMENT REGARDING FEDERALLY SPONSORED RESEARCH OR DEVELOPMENT

None.

### REFERENCE TO A “SEQUENCE LISTING”

Not applicable.

### BACKGROUND OF THE INVENTION

1. Field of the Invention

Embodiments of the present disclosure relate to optical component systems, and in particular, to systems facilitating the manipulation of optical components relative to light incidence thereon.

2. Description of Related Art

The properties of certain optical components (such as filters) depend on the angle of incidence of the incoming light. The selection of angle of incidence for a single optical component can be facilitated simply by attaching the optical component to a pivot and actuating the pivot with a motor. The usefulness of these optical components could be enhanced with a device capable of placement of one out of several of these optical components, each with different optical properties, in the optical path and selection of the angle of incidence between the incoming light and the selected optical component.

Unfortunately, known optical component systems do not enable the user to easily select one or more optical components from among a plurality of like components, while at the same time, enabling the user to manipulate and/or otherwise position the one or more selected optical components relative to one or more beams of light incidence thereon. The embodiments of the present disclosure are aimed at overcoming these deficiencies.

### BRIEF SUMMARY OF THE INVENTION

In an exemplary embodiment of the present disclosure, the optical component system includes a base, a carousel rotatable with respect to the base, and a plurality of optical components coupled to the carousel wherein at least one of the plurality of optical components comprises a lens, wherein the plurality of optical components are disposed substantially perpendicular to the carousel, and wherein the carousel is rotatably driven by an actuation device coupled thereto. The system further includes a pivot coupling the carousel to the actuation device wherein the actuation device comprises a stepper motor, wherein the actuation device is disposed proximate a first side of the base and the carousel is disposed proximate a second side of the base opposite the first side and wherein the carousel is selectively rotatable relative to the base such that at least one of the plurality of optical components may form a predetermined angle of incidence with an incoming light beam.

In yet another exemplary embodiment of the present disclosure, the system includes an angle of incidence between the light beam and the at least one optical component that is approximately 90 degrees, wherein the angle of incidence between the light beam and the at least one optical component is between approximately 60 degrees and approximately 90 degrees.

In still another exemplary embodiment, at least one of the plurality of optical components is disposed substantially perpendicular to the carousel, wherein at least one of the plurality of optical components is disposed at an angle between approximately 60 degrees and approximately 90 degrees relative to the carousel.

In a further exemplary embodiment of the present disclosure, the optical component system includes a base, a plurality of optical components, each of the plurality of optical components disposed on a respective post extending at least partially through the base, and an actuation device configured to alter a position of at least one of the respective posts relative to the base.

In such an exemplary embodiment, the actuation device is configured to alter a position of at least one of the plurality of optical components by altering the position of the at least one post, wherein at least one of the plurality of optical components comprises a mirror wherein the plurality of optical components comprises a first plurality of mirrors and a second plurality of mirrors, each mirror of the first plurality of mirrors having a respective first optical surface substantially parallel to a second optical surface of a corresponding mirror of the second plurality of mirrors, wherein the plurality of optical components further comprises a third plurality of optical components disposed between the first and second plurality of mirrors, wherein the first plurality of mirrors is moveable in concert with at least one of the second plurality of mirrors and the third plurality of optical components, wherein the first plurality of mirrors is rotatable in concert with at least one of the second plurality of mirrors and the third plurality of optical components.

### BRIEF DESCRIPTION OF THE SEVERAL VIEWS OF THE DRAWING(S)

FIG. 1 is an isometric view of an optical component system according to an exemplary embodiment of the present disclosure.

FIG. 2 is a top view of the system shown in FIG. 1.

FIG. 3 is an isometric view of an optical component system according to another exemplary embodiment of the present disclosure.

FIG. 4 is an illustration of an optical component system.

FIG. 5 is another illustration of an optical component system.

FIG. 6 is still another illustration of an optical component system.

FIG. 7 is a further illustration of an optical component system.

FIG. 8 is yet another illustration of an optical component system.

FIG. 9 is still another illustration of an optical component system.

FIG. 10 is still a further illustration of an optical component system.

FIG. 11 is another illustration of an optical component system.

### DETAILED DESCRIPTION OF THE INVENTION

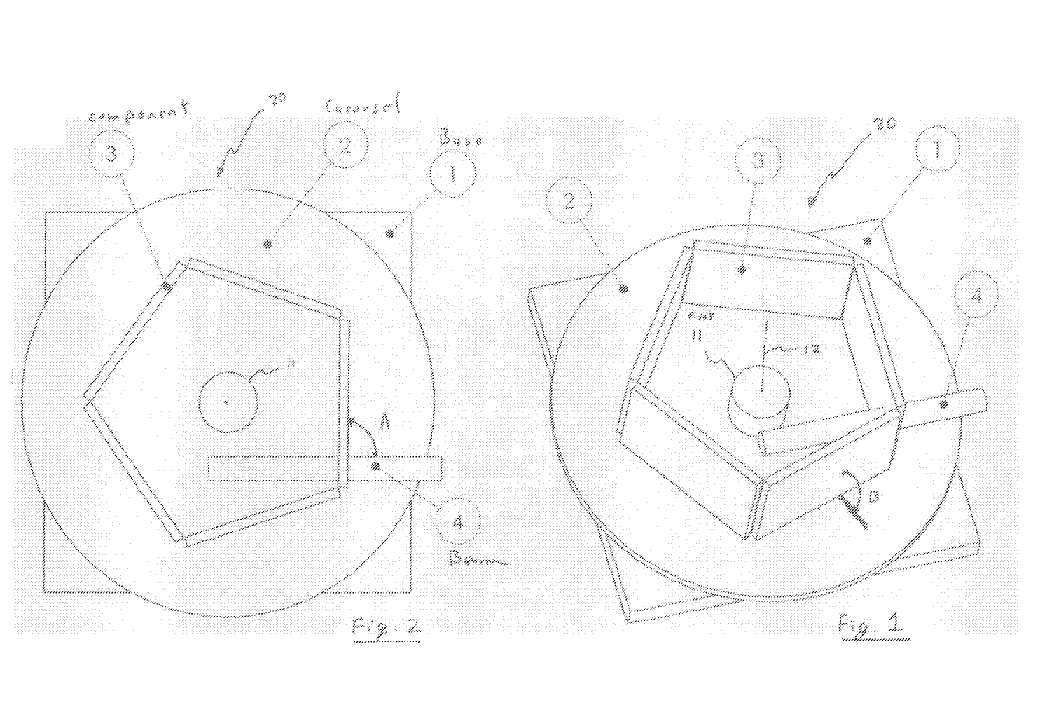

As shown in FIGS. 1 and 2, in an exemplary embodiment of the present disclosure, an optical component system 20 may include a base 1, a pivot 11, and a carousel 2 rotatably coupled to the base 1 around the pivot 11. The optical component system 20 also includes a plurality of optical components 3 connected to the carousel 2. Such optical components 3 may be, for example, any of a number of known components useful in shaping and/or directing one or more beams of radiation. Such optical components 3 may include, for example, any known mirror, lens, prism, window, and/or other like optical component. Such components 3 may, for example, be configured to collimate, reflect, refract, polarize, diffract, and/or otherwise act upon a beam 4 of radiation (such as light) in any desirable way. Such beams 4 may impinge upon the one or more components 3 at any desirable angle A. In an exemplary embodiment, such an angle A of incidence between the light beam 4 and the component 3 may be between approximately 30 degrees and approximately 90 degrees.

The optical components 3 may be connected to the carousel 2 in any convenient manner. For example, such components 3 may be adhered, clamped, and/or otherwise fixedly connected to the carousel 2 such that rotation of the carousel 2 about the pivot 3 may cause like rotation of each of the components 3. Although illustrated in FIGS. 1 and 2 as being disposed substantially perpendicular to the upper surface of the carousel 2, in additional exemplary embodiments, each of the components 3 may be disposed at any desirable angle B relative to the upper surface of the carousel 2. Such angles B may be chosen to diminish the need and/or eliminate the need for additional upstream and/or downstream optical components within the system 20. Such additional components (not shown) may include, for example, additional collimating lenses, mirrors, windows, diffractive lenses, and the like.

As shown in FIG. 1, the beam 4 may be directed along a path substantially perpendicular to a central axis 12 of the pivot 11, and such a path may be substantially parallel to the top surface of the carousel 2. In an exemplary embodiment, an optical surface of at least one of the optical components 3 may be disposed substantially perpendicular to the top surface of the carousel 2, and in such an exemplary embodiment, the beam 4 may pass through one of the optical components 3. It is understood that the system 20 may further include one or more additional components 3, such as a collimating lens, a mirror, a prism, or other like component that is disposed in any useful position relative to the components 3. Such additional components may assist in directing the beam 4 to impinge upon the desired component 3 at any desired angle A. For example, one or more mirrors or other like optical components may be disposed between, for example, the axis 12 and the plurality of optical components 3. Such a mirror may assist in folding the optical path of the beam 4 such that the beam path is substantially parallel to the axis 12 at a point optically upstream and/or downstream of the optical components 3.

It is understood that the system 20 may further include one or more rotation devices (not shown). Such devices may be coupled to the carousel 2 in any known way to facilitate rotation of the carousel 2 around the axis 12. For example, one or more such rotation devices may be disposed on the underside of the base 1 and may be coupled to the carousel 2 through the base 1. In an additional exemplary embodiment, such a device may be coupled to, for example, the pivot 11. In such an exemplary embodiment, the rotation device may rotate the pivot 11 about the axis 12, and the carousel 2 may be substantially fixedly coupled to the pivot 11. The pivot 11 may extend at least partially through the base 1. Accordingly, rotation of the pivot 11 by the rotation device may cause a corresponding rotation of the carousel 2. Through this arrangement, optical component selection and incidence angle selection may be facilitated by a single actuator and/or other rotation device. Such rotation devices may be, for example, any electromechanical device configured to facilitate rotation of one or more components connected thereto, and such devices may include, for example, solenoids, stepper motors, and/or other like devices. Such devices may be further connected to, for example, any known controller, power supply, driver, and/or other components required for activation and control. During operation, as the carousel 2 is rotated around the pivot axis 12, the angle of incidence A between the beam 4 and the optical component 3 changes. In addition, rotation of the carousel 2 may result in placement of an adjacent optical component 3 in the optical path of the beam 4. This adjacent optical component 3 can then be moved, by rotation of the carousel 2, to form any new desired angle of incidence A with the light beam 4. Due to the simplicity of the design described herein, it may be possible to achieve both optical component selection and incidence angle selection at relatively high speeds with a high level of accuracy.

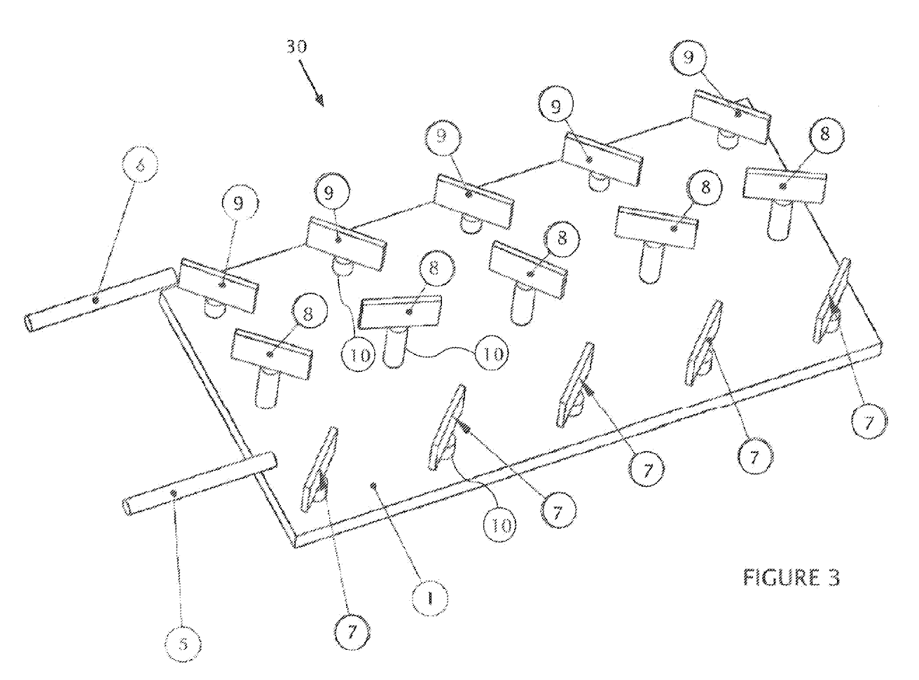

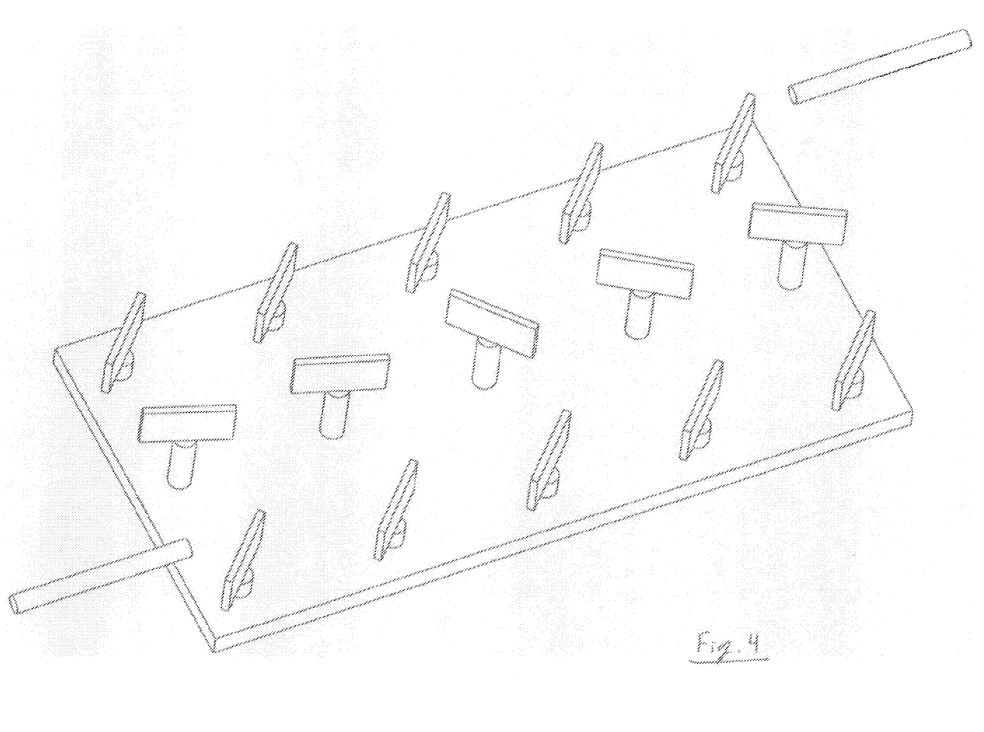

As shown in FIG. 3, in an additional exemplary embodiment of the present disclosure, an optical component system 30 may include a base 1, a plurality of optical components 7, 8, 9, and a plurality of posts 10 connecting each of the respective optical components 7, 8, 9 with the base 1. Each of the posts 10 may extend at least partially through the base 1. In an exemplary embodiment, each of the posts 10 and the respective optical components 7, 8, 9 may be movable up and down relative to the base 1 in a direction substantially perpendicular to the base 1. In addition, each of the optical components 7, 8, 9 may be rotated relative to the base 1 by rotating the corresponding post 10 to which the component 7, 8, 9 is connected. Each of the posts 10 may be individually connected to a respective actuation device (not shown) disposed beneath the base 1. Such actuation devices may be similar to the rotation devices discussed above with regard to the system 20. In addition, such actuation devices may include any one of a number of pneumatic, electromagnetic, and/or other known linear actuators for facilitating the up and down movement of the post 10. Such actuation devices may also facilitate the rotation of the posts 10 in a clockwise and/or counterclockwise direction. Alternatively, two or more of the posts 10 may be connected to the same actuation device thereby facilitating the synchronized movement of the two or more posts 10 and their associated optical components 7, 8, 9. Such an arrangement may reduce the number of actuation devices required for operation of the system 30.

In an exemplary embodiment, the system 30 may include a first plurality of optical components 7 arranged with optical surfaces substantially parallel to each other. For example, in such an exemplary embodiment, the system 30 may include a first multitude of mirrors 7 with surfaces parallel to each other, each attached to the base 1 in one of two positions, with the center of each lying on the one of two parallel lines, with means of individually selecting one of the two positions for each mirror 7. Such a means may be one of the actuation devices described above.

Such an exemplary system 30 may also include a second multitude of optical components 8, each rotatably connected to the base 1, each individually rotatable with a separate actuator, with the center of all optical components 8 situated coplanar with a line that connects the centers of the first multitude of mirrors 7 in one of the two positions.

Such an exemplary system 30 may further include a third multitude of mirrors 9 with surfaces parallel to each other and perpendicular to the surfaces of the first multitude of mirrors 7, each attached to the base 1 in one of two positions or orientations, with the center of each lying on the one of two parallel lines, each forming a pair with one of the mirrors 7 from the first multitude such that both mirrors are actuated at the same time, with a line connecting the centers of the mirror pair being parallel to the surface of the base 1, with the center of one of the multitude of optical components lying on the line connecting the mirror pair.

As shown in FIG. 3, an incoming light beam 5 may be directed coplanar with a line connecting the centers of the optical components 7, collinear with the centers of the first multitude of mirrors 7 in one of the two positions.

An outgoing light beam 6 may be directed coplanar with a line connecting the centers of the optical components 9, collinear with the centers of the second multitude of mirrors 8 in one of the two positions.

Initially, all mirrors 7 in the first multitude clear the incoming light path, all mirrors 8 in the second multitude clear the outgoing light path. An optical component is selected from the multitude by positioning a single pair of mirrors, one from the first multitude and one from the second multitude, such that the incoming light 5 is reflected from the first multitude mirror 7, passes through the optical component 8, and is reflected from the second multitude mirror 9 to form the outgoing light beam 6. The optical component 8 is rotated to form a desired angle with the incidence light. The mirror pair forming the current light path must be retracted to clear the incoming and outgoing light path before a different optical component 8 can be selected.

In the exemplary embodiment illustrated in FIG. 3, surfaces of the second multitude of mirrors 9 can be parallel to the surfaces of the first multitude of mirrors 7 resulting in the same direction of propagation of the incoming 5 and outgoing 6 light beams. The first multitude mirror 9 furthest from the incoming light path can be omitted. The second multitude mirror 9 furthest from the outgoing light path can be omitted. The mirrors 7, 9 can be articulated between the two positions along linear or circular trajectories. The optical components 8 can be articulated over their range of positions with a linear or rotary actuator. The rotation of the optical components can be linked (such as by means of a belt) and controlled with a single actuator. The axes of the pivots of all optical components 7, 8, 9 can be colinear such that a single pivot actuates all optical components 7, 8, 9 at the same time, the single pivot axis would be parallel to the incoming and outgoing light beam.

In the exemplary embodiment of FIG. 4, the mirror surfaces of the first plurality are parallel to the surfaces of the mirrors of the second plurality and the direction of propagation of the outgoing light is the same as the direction of propagation of the outgoing light.

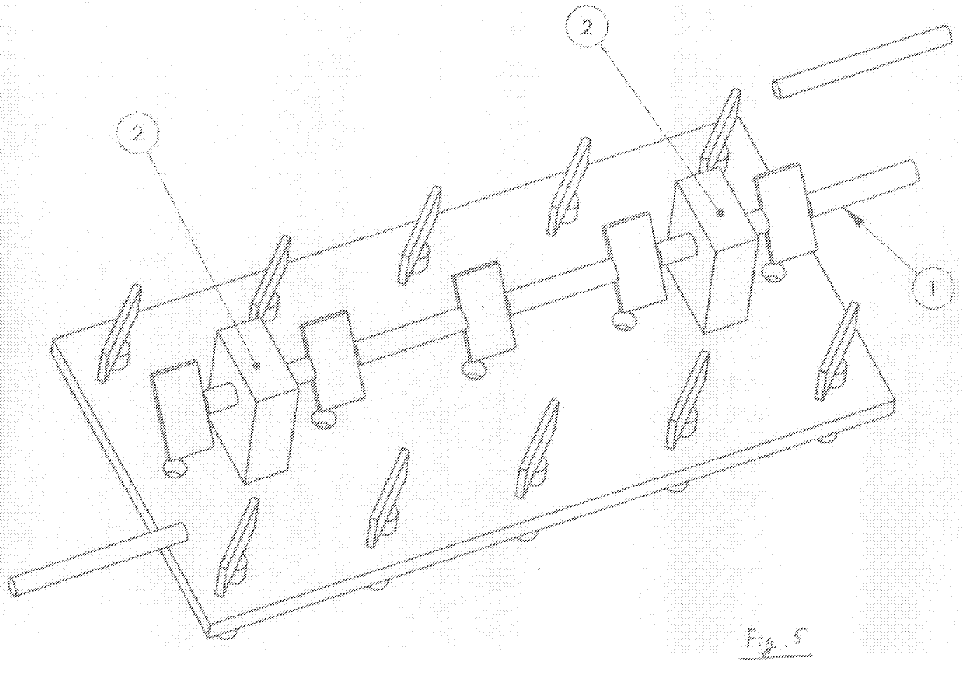

In the exemplary embodiment of FIG. 5, the pivots of all optical components are linked (item 1), allowing for a single actuator to select the position of the optical component. Items 2 represent pivot holders attached to the base that hold the optical component pivot.

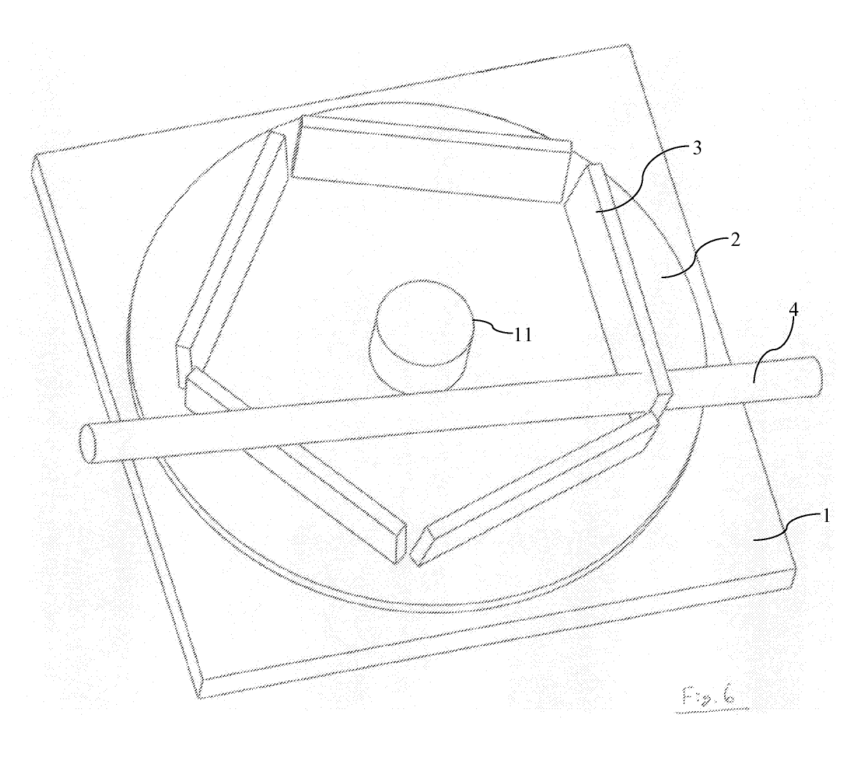

In the exemplary embodiment of FIG. 6, the arrangement between the optical components and the surface of the carousel is substantially non-perpendicular, allowing for a straight optical path through the apparatus.

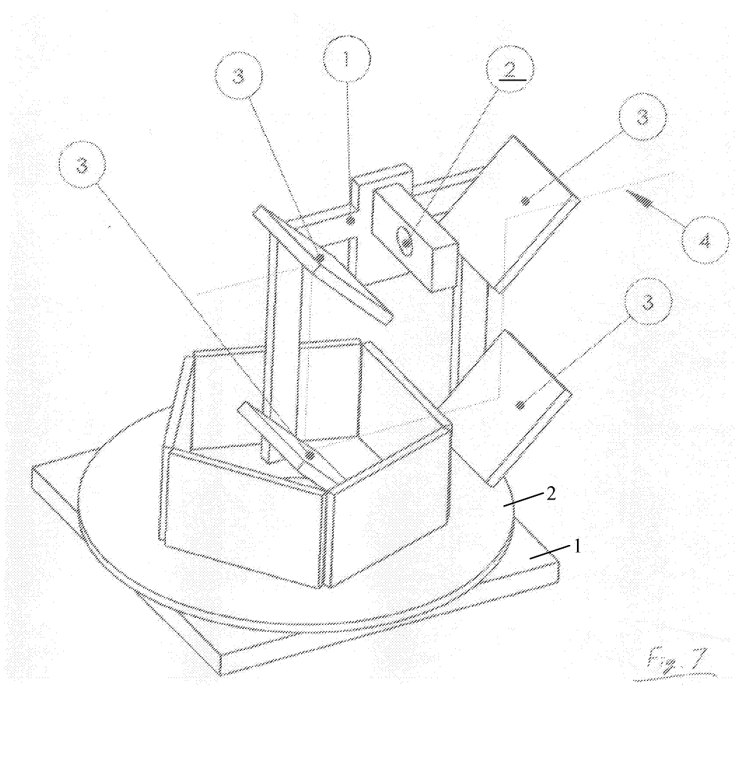

The exemplary system shown in FIG. 7 is derived from the exemplary systems shown in FIGS. 1, 2, and 6, with the addition of these comjponents: mirror holder; pivot holder attached to mirror holder, rotatably coupling the mirror holder with a pivot stationary in the reference frame of the base, where the mirror holder can be actuated to various angles by electro-mechanical means, where the angular motion of the mirror holder may be linked the motion of the carousel, or may be moved independently of the carousel motion; plurality of mirrors; optical path folded via Plurality of mirrors, where the incoming and outgoing axis are substantially colinear, where the optical path passes through one of the plurality of optical components. This embodiment increases the maximum achievable beam size for a given optical component size.

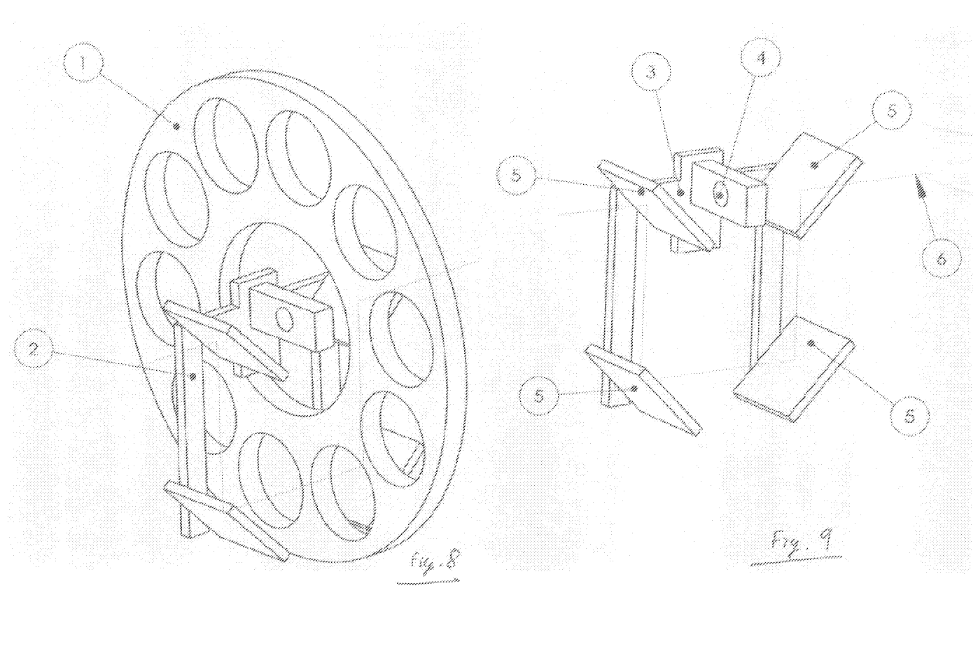

As shown in FIGS. 8 and 9, in still another exemplary embodiment of the present disclosure, an optical component system includes the following elements: stationary carousel with a plurality of optical component holding locations, where the holding locations are arranged symmetrically around an axis; optical path folding apparatus consisting of mirror holder, pivot holder attached to mirror holder, rotatably coupling the mirror holder with a pivot stationary in the reference frame of the carousel, where the pivot axis is colinear with the axis of symmetry of the optical component holding locations in the carousel, where the mirror holder can be actuated to various angles by electro-mechanical means; plurality of mirrors; optical path folded via plurality of mirrors, where the incoming and outgoing axis are substantially colinear, where the optical path passes through one of the plurality of optical locations.

The optical path can be diverted by means of rotating the optical path folding apparatus, such that it passes through one of the optical components held in the carousel.

Due to the low mass and low moment of inertia of the optical path folding apparatus compared to a filter wheel populated with filters, it is possible to activate different optical components with less power and/or at higher speeds in optical setups with subtantially collimated light. The moment of inertia is largely constituted by the mass of the two mirrors that don't inersect the axis of rotation of the optical path folding apparatus and offers a signifficant reduction in comparison with a plurality of optical components located in a filter wheel.

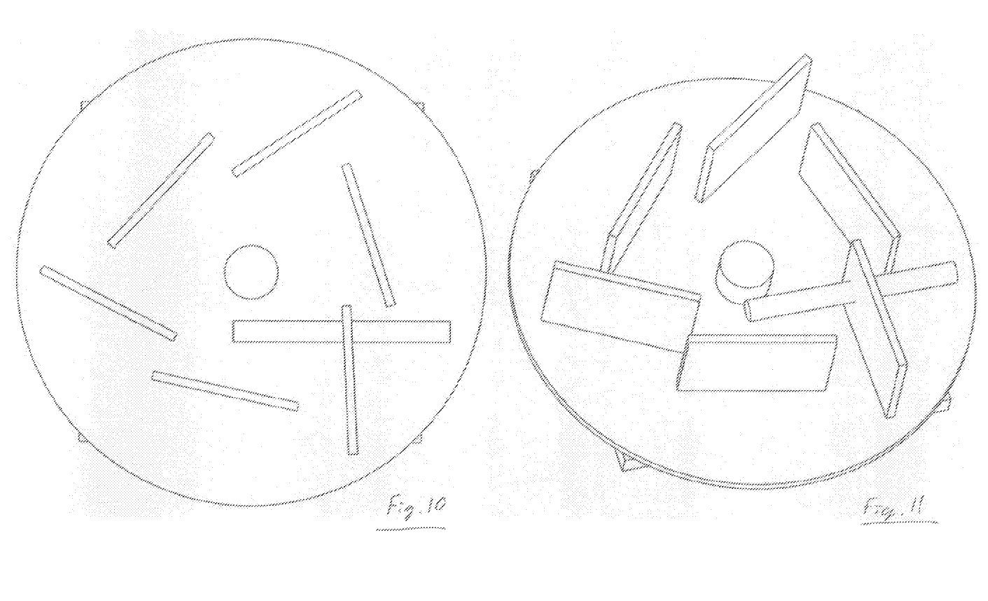

As shown in FIGS. 10 and 11, in a further exemplary embodiment, the optical component system may have a different placement of the optical components on the carousel.

1. An optical component system, comprising:
(a) a base;
(b) a carousel rotatable with respect to the base; and
(c) a plurality of optical components coupled to the carousel.

2. The system of claim 1, wherein at least one of the plurality of optical components comprises a lens.

3. The system of claim 1, wherein the plurality of optical components are disposed substantially perpendicular to the carousel.

4. The system of claim 1, wherein the carousel is rotatably driven by an actuation device coupled thereto.

5. The system of claim 4, further including a pivot coupling the carousel to the actuation device.

6. The system of claim 4, wherein the actuation device comprises a stepper motor.

7. The system of claim 4, wherein the actuation device is disposed proximate a first side of the base and the carousel is disposed proximate a second side of the base opposite the first side.

8. The system of claim 4, wherein the carousel is selectively rotatable relative to the base such that at least one of the plurality of optical components may form a predetermined angle of incidence with an incoming light beam.

9. The system of claim 8, wherein the angle of incidence between the light beam and the at least one optical component is approximately 90 degrees.

10. The system of claim 8, wherein the angle of incidence between the light beam and the at least one optical component is between approximately 60 degrees and approximately 90 degrees.

11. The system of claim 1, wherein at least one of the plurality of optical components is disposed substantially perpendicular to the carousel.

12. The system of claim 1, wherein at least one of the plurality of optical components is disposed at an angle between approximately 60 degrees and approximately 90 degrees relative to the carousel.

13. An optical component system, comprising:
(a) a base;
(b) a plurality of optical components, each of the plurality of optical components disposed on a respective post extending at least partially through the base; and
(c) an actuation device configured to alter a position of at least one of the respective posts relative to the base.

14. The system of claim 13, wherein the actuation device is configured to alter a position of at least one of the plurality of optical components by altering the position of the at least one post.

15. The system of claim 13, wherein at least one of the plurality of optical components comprises a mirror.

16. The system of claim 13, wherein the plurality of optical components comprises a first plurality of mirrors and a second plurality of mirrors, each mirror of the first plurality of mirrors having a respective first optical surface substantially parallel to a second optical surface of a corresponding mirror of the second plurality of mirrors.

17. The system of claim 16, wherein the plurality of optical components further comprises a third plurality of optical components disposed between the first and second plurality of mirrors.

18. The system of claim 17, wherein the first plurality of mirrors is moveable in concert with at least one of the second plurality of mirrors and the third plurality of optical components.

19. The system of claim 17, wherein the first plurality of mirrors is rotatable in concert with at least one of the second plurality of mirrors and the third plurality of optical components.
